(19) United States
(12) Patent Application Publication
(10) Pub. No.: US 2007/0230359 A1
(43) Pub. Date: Oct. 4, 2007

(54) Path alarm processing method and device

(75) Inventor: Masaru Tanaka, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/485,854

(22) Filed: Jul. 13, 2006

(30) Foreign Application Priority Data
Mar. 31, 2006 (JP) 2006-099208

(51) Int. Cl. H04J 3/14

(52) U.S. Cl. 370/248; 370/392

(57) ABSTRACT

A path alarm processing method and device perform an alarm mask designation for an ADMIN_STATUS object of a GMPLS path message used upon path setup, and an alarm mask release designation for unused bits of a Sub-TLV object additionally generated. When an alarm generation and its recovery are recognized during alarm monitoring, the alarm mask release designation is confirmed to release an alarm mask. As the above-mentioned alarm mask release designation, at least any one of a lapse of a fixed time by a timer after a path setup, a predetermined message indicating an alarm mask release, and a predetermined number of receptions of the predetermined message can be designated.

### BACKGROUND OF THE INVENTION

1. Field of the Invention

The present invention relates to a path alarm processing method and device, and in particular to a method and device processing a path alarm which is automatically generated upon path setup within a network by using GMPLS (Generalized Multi-Protocol Label Switching).

2. Description of the Related Art

Path alarms are generated at nodes where paths have been already set up until all of the paths are set up in nodes extending from a path start node to a path end node within a network. For this reason, there are problems that an upper monitoring device and a monitoring network get overloaded, and a manpower cost is required for a determination or the like of whether or not the alarms are associated with a new path setup.

In order to solve these problems, a preliminary operation such as alarm mask processing to a path setup section has been artificially performed upon path setup by a recommendation (RFC 3473).

FIG. 9 shows a sequence exemplifying a process of a path setup (signaling) between a start node (Ingress) N1 and an end node (Egress) N4 of a path section by using GMPLS and alarm mask processing based on the above-mentioned recommendation (RFC 3473).

Firstly, the node N1 transmits to an adjoining intermediate node N2 through a monitoring line (not shown) a path message PathMsg (see FIG. 10A) designating path information (Explicit_Route Object: ERO) between the nodes Ni and N4 and a path No. (TDM: Time Slot WDM: wavelength multiplexing) desired to be used between the nodes N1 and N2.

When the path No. designated by the path message PathMsg received is valid (unused), the node N2 puts the concerned path No. to a reserved state, and transfers the similar path message PathMsg to a subsequent intermediate node N3. The node N3 also performs the same processing as that of the node N2 to transfer the path message PathMsg to the end node N4.

As shown in FIG. 10A, an “ADMIN_STATUS” object (field) is assigned in the path message PathMsg transferred. The above-mentioned recommendation (RFC 3473) prescribes that an A-bit designation (Admin Down designation) and a T-bit designation (Test Mode) are performed by this “ADMIN_STATUS” object, and the alarm mask processing is executed in the nodes N1-N4 upon reception of the path message PathMsg as shown in FIG. 9.

Hereafter, when the path message PathMsg received is valid, the node N4 transmits a reserve message ResvMsg (see FIG. 10B) which is a response indicating “OK” also through the monitoring line and executes a path setup (cross-connect setup) to the node N4 itself.

The node N3 having received the reserve message ResvMsg from the node N4 transmits the reserve message ResvMsg to the node N2 and executes the path setup to the node N3 itself in the same way as the above-mentioned node N4. The same processing is executed to the nodes N2 and N1, so that the path setup between the nodes N1 and N4 is completed. It is to be noted that the node N1 does not transmit the reserve message ResvMsg.

It is to be noted that the content of the path message PathMsg shown in FIG. 10A is basically as follows:

SESSION, SENDER_TEMPLATE: These are fields (objects) for storing identifying information of a connection, which enable a unique identification by combining five pieces of information (ingress address, egress address, tunnel ID, LSPID, and extension tunnel ID);

RSVP_HOP: This is a field for storing a local ID of a transmission side node of the path message PathMsg as identifying information of a fiber used;

TIME_VALUES: This is a field for storing a path refresh interval (refresh timer length). A reception side determines a PTTD based on this value. A value of 20-30 seconds is generally stored therein;

EXPLICIT_ROUTE: This is a field for storing information of a path through which a connection passes;

LABEL_REQUEST: This is a field for storing a type of a label requested, and indicates what is a connection like (SDH/SONET, Ethernet (registered trademark), Lambda);

PROTECTION: This is a field for storing kinds of a protection requested by a connection or the like, and is related to a segment protection;

SESSION_ATTRIBUTE: This is a field for storing a connection name or the like, and is used for specifying a connection by using the name when RTRV is performed to the connection by a relay node;

ADMIN_STATUS: This is a field for storing specific information such as Admin_Down and Deletion;

SENDER_TSPEC: This is a field for storing rate information (2.5 G, 10 G, or the like) requested by the connection, and indicates presence/absence of STS1/STS3c/concatenation in case of SONET; and

UPSTREAM_LABEL: This is a field for storing reserved label information (information identifying wavelength).

Also, the content of the reserve message ResvMsg shown in FIG. 10B is basically as follows:

RESV_CONFIRM: This is a field for storing information when the transmission of ResvConfMsg is requested;

FLOWSPEC: This is a field for storing identifying information of the same connection as the SENDER_TEMPLATE of the path message PathMsg;

FILTERSPEC: This is a field for storing rate information requested similar to the SENDER_TSPEC of the path message PathMsg; and

LABEL: This is a field for storing the same label information as UPSTREAM_LABEL of the path message PathMsg.

FIG. 11 shows an arrangement common to the nodes N1-N4 performing the above-mentioned path setup and alarm mask processing.

Each node is schematically composed of a device control unit 1, a communication control unit 2, a monitoring device 3 connected to the device control unit 1, an interface/cross-connect unit 4 connected to the device control unit 1 and performing an opto-electrical signal conversion and an exchange operation, and an SDH/SONET overhead terminating unit 5 connected between the communication control unit 2 and the interface/cross-connect unit 4.

Among the units, the device control unit 1 processes an optical main signal, and the communication control unit 2 processes the path message PathMsg and the reserve message ResvMsg flowing through the monitoring line. Also, the device control unit 1 is composed of a user interface 11 connected to the monitoring device 3, a command processor 12 interconnected to the user interface 11, a device controller 13 and an alarm controller 14 connected to the interface/cross-connect unit 4, a database 15 storing information of a path setup, and an inter-CPU communication controller 16 interconnected to the command processor 12 and the alarm controller 14. It is to be noted that the device controller 13 and the alarm controller 14 are interconnected, and the command processor 12 and the alarm controller 14 are also interconnected.

Also, the communication control unit 2 is composed of an inter-CPU communication controller 21 interconnected to the inter-CPU communication controller 16 of the device control unit 1, a GMPLS controller 22 connected to the inter-CPU communication controller 21, a communication controller 23 connected to the GMPLS controller 22, and a data communication channel controller 24 connected between the communication controller 23 and the overhead terminating unit 5, and controlling the data communication channel (DCC).

An operation example of the path setup processing and the alarm mask processing shown in FIG. 9 in each of the nodes of the above arrangement will now be described separately for the start node N1, the intermediate node N2 or N3, and the end node N4.

Operation Example of Start Node: FIG. 12

Firstly, a user inputs a path setup command to the user interface 11 of the device control unit 1 from the monitoring device 3 (at step S1). In this case, an alarm mask designation set in the “ADMIN_STATUS” object shown in FIG. 10A is included in the path setup command.

The path setup command is transmitted from the user interface 11 to the command processor 12 to be held temporarily. The command processor 12 requests the alarm controller 14 to execute an alarm mask (at step S2). The alarm controller 14 having received this alarm mask execution request executes the alarm mask (at step S3).

Then, the command processor 12 requests the GMPLS controller 22 to transmit the path message PathMsg through the inter-CPU communication controller 16 and the inter-CPU communication controller 21 of the communication control unit 2 (at step S4). The GMPLS controller 22 having received the request transmits the path message PathMsg to the overhead terminating unit 5 from the data communication channel controller 24 through the communication controller 23, and further transmits the path message PathMsg from the overhead terminating unit 5 to the adjoining node N2 through the interface/cross-connect 4 (at step S5).

In this case, the sequence in the GMPLS protocol is made with a DCC communication (IP over DCC) that is a high speed communication performed by using a part of an overhead in the data line transmitting a main signal or through a LAN, and is made by a packet of a conventional IP protocol. Namely, GMPLS data is carried on the payload part of the IP packet, and is transmitted/received between nodes. However, as for the monitoring data for path setup, the data is transmitted/received through the monitoring line using the overhead (DCC) of the main signal. Namely, both of DCC and LAN are used as the monitoring line for each node composing a normal network.

In response to the path message PathMsg thus transmitted from the node N1, the reserve message ResvMsg is transmitted from the end node N4 as mentioned above through DCC/LAN in the same way as the path message PathMsg, so that the node N1 receives the reserve message ResvMsg from the adjoining node N2 (at step S6). The GMPLS controller 22 having received the reserve message ResvMsg through the interface/cross-connect unit 4, the overhead terminating unit 5, the data communication channel controller 24, and the communication controller 23 requests the command processor 12 through the inter-CPU communication controllers 21 and 16 to control the path setup (at step S7).

In response to the request, the command processor 12 requests the device controller 13 to control the path setup (at step S8). The device controller 13 having received the request executes the path setup to the interface/cross-connect unit 4 based on the information of the database 15, and requests the alarm controller 14 to start alarm monitoring (at step S9).

It is to be noted that the path setup between the start node N1 and the end node N4 has not been substantially completed at this time (at step T1).

Then, the alarm controller 14 makes the interface/cross-connect unit 4 start the path alarm monitoring (at step S10). This is determined by whether the optical level is normal, no payload data exists in the main signal (UNEQ), or an AIS signal is inserted (AIS) (at step S11).

As a result of the determination at step S11, the interface/cross-connect unit 4 notifies the state to the alarm controller 14 (alarm notification) (at step S12). The alarm controller 14 having received the notification recognizes the generation of an alarm (UNEQ/AIS/etc) (at step S13). However, the alarm controller 14 does not notify the alarm to the monitoring device 3 even if the alarm is generated, since the alarm mask executed at step S3 is now being processed (at step S14).

It is supposed that the path setup in all of the nodes between the start node N1 and the end node N4 is completed at this point (at step T2).

Hereafter, the interface/cross-connect unit 4 notifies the state change (recovery of alarm) to the alarm controller 14 (at step S15), and the alarm controller 14 recognizes that the alarm state has been recovered (at step S16). Nevertheless, since the alarm mask is still being executed, the alarm controller 14 does not notify the alarm recovery to the monitoring device 3 (at step S17).

As a result, the alarm mask state continues (at step T3).

Operation Example of Intermediate Node: FIG. 13

The operation example of the intermediate node is different from that of the start node shown in FIG. 12 in that steps S21-S24 are added and steps S1, S2, and S4 are omitted.

Namely, taking the node N2 as the intermediate node for example, the node N2 receives the path message PathMsg through the monitoring line (LAN or DCC) (at step S21). This path message PathMsg is received by the GMPLS controller 22 through the interface/cross-connect unit 4, the overhead terminating unit 5, the data communication channel controller 24, and the communication controller 23. In this path message PathMsg received, the alarm mask is designated at the “ADMIN_STATUS” object.

In response to the path message PathMsg, the GMPLS controller 22 requests the alarm controller 14 in the device control unit 1 to execute the alarm mask through the inter-CPU communication controllers 21 and 16 (at step S22).

Thus, the alarm controller 14 executes the alarm mask (at step S3), and notifies the completion of the alarm mask to the GMPLS controller 22 (at step S23).

Hereafter, steps S5-S9 are executed in the same way as the operation example of FIG. 12, in which the transmission of the path message PathMsg and the reception of the reserve message ResvMsg are performed, so that the alarm controller 14 starts the alarm monitoring for the interface/cross-connect unit 4.

The GMPLS controller 22 transmits the reserve message ResvMsg to the adjoining node N1 (at step S24), and starts the alarm monitoring (at step S10).

Subsequent steps S10-S17 are the same as the operation example of the start node shown in FIG. 12.

Since the alarm recovery notification to the monitoring device 3 is prevented at step S17, the alarm mask state continues (at step T3).

Operation Example of End Node: FIG. 14

This operation example of the end node is different from that of the intermediate node shown in FIG. 13 in that steps S5 and S6 are omitted.

Namely, only steps of transmitting the path message PathMsg to the adjoining node and of receiving the reserve message ResvMsg from the adjoining node are omitted, while other steps are the same as those of the intermediate node. Accordingly, the alarm recovery notification to the monitoring device 3 is also prevented at step S17, thereby leaving the alarm mask state to be continued (at step T3).

On the other hand, there is a system comprising a plurality of information transfer nodes setting up a transmission line between the node devices and transmitting/receiving information through the transmission line, and a service quality control node transmitting instructions for resetting the transmission line to the information transfer nodes according to a result of monitoring a network state realized by the information transfer nodes. The system can perform a control satisfying a service quality with a transmission line composed dynamically and flexibly by performing the instructions for resetting the transmission line to a plurality of information transfer node devices according to the monitoring result (see e.g. patent document 1).

[Patent document 1] Japanese Patent Application Laid-open No. 2004-247943

As mentioned above, while the alarm mask with the object (ADMIN_STATUS object) included in the message (PathMsg) upon path setup by using the GMPLS is prescribed in the recommendation (RFC 3473), there has been a problem that the alarm mask state continues, so that only releasing has to be artificially executed to the nodes.

### SUMMARY OF THE INVENTION

It is accordingly an object of the present invention to provide a path alarm processing method and device which can easily and promptly release an alarm mask designation upon path setup.

In order to achieve the above-mentioned object, a path alarm processing method (or device) according to the present invention comprises: a first step of (or means) performing an alarm mask release designation together with an alarm mask designation upon path setup; and a second step of (or means) releasing an alarm mask based on the alarm mask release designation when a recovery of a generated alarm is recognized during alarm monitoring.

Namely, in the present invention, while an alarm mask designation is performed upon path setup in the same way as the prior art example, an alarm mask release designation is also performed concurrently. When a generation of an alarm is recognized and a recovery thereof is recognized during alarm monitoring, the alarm mask release designation is confirmed. As a result, when it is found that the alarm mask release designation has been performed, the alarm mask release is performed with this designation as a trigger.

The path setup in this case may use a path setup by GMPLS.

In a start node or the like, the alarm mask designation and the alarm mask release designation may be performed upon path setup command input. In an intermediate or end node, the alarm mask designation and the alarm mask release designation may be performed by confirming whether or not a path message received upon path setup is stored in a predetermined field.

Also, the above-mentioned predetermined field may be an ADMIN_STATUS field (object) in the path message PathMsg as shown in e.g. FIG. 1. Unused bits of a Sub-TLV field in the ADMIN_STATUS field can be assigned to the alarm mask release designation.

For the above-mentioned alarm mask release designation, by using unused bits of the Sub-TLV field, at least any one of a fixed time having passed after the path setup (timer system), a predetermined message indicating the alarm mask release (message system), and a predetermined number of receptions of the predetermined message (message reception number system) can be designated.

As mentioned above, according to the present invention, the alarm mask release is automatically executed upon alarm recovery by presetting a release trigger to the alarm mask, thereby realizing rapid and accurate alarm mask release.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a format diagram showing an example of a path message of GMPLS used for an embodiment of a path alarm processing method and device according to the present invention;

FIG. 2 is a flowchart showing an embodiment at the time when a node realizing a path alarm processing method and device according to the present invention operates at a start point;

FIG. 3 is a flowchart showing Sub-TLV generation processing commonly used for nodes used in the present invention;

FIGS. 4A and4B are diagrams showing an old format and a new format of an ADMIN_STATUS object in a path message of GMPLS generally known;

FIGS. 5A-5C are format diagrams showing a structure of a Sub-TLV object added by the present invention;

FIG. 6 is a flowchart showing alarm mask release processing commonly used for nodes by the present invention;

FIG. 7 is a flowchart showing an operation embodiment of an intermediate node in the present invention;

FIG. 8 is a flowchart showing an operation embodiment of an end node in the present invention;

FIG. 9 is a diagram showing a generation sequence of a bidirectional path by GMPLS;

FIGS. 10A and 10B are format diagrams of a path message and a reserve message used for GMPLS conventionally known;

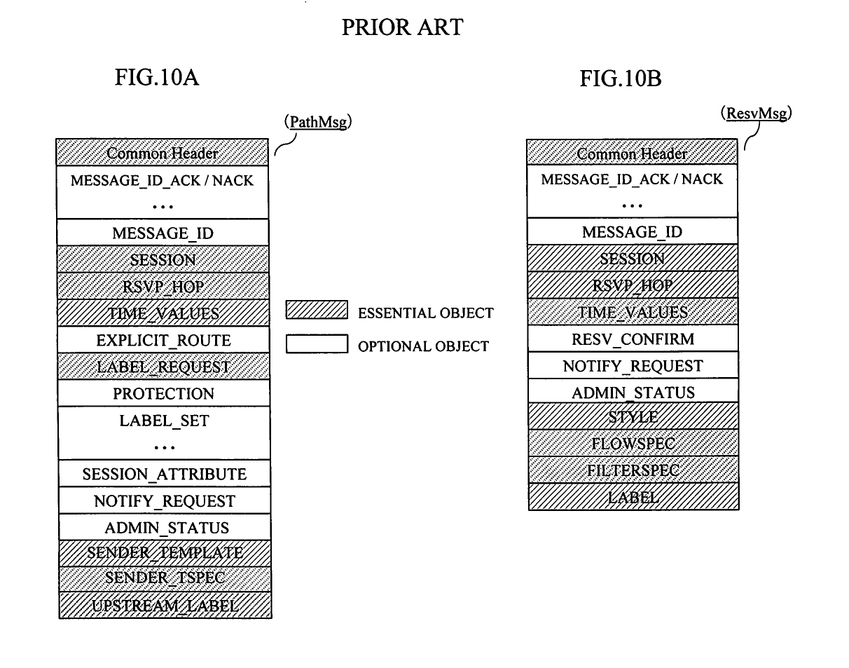

FIG. 11 is a block diagram showing an arrangement of nodes common to both of the present invention and the prior art example;

FIG. 12 is a flowchart showing an operation example of a start node in the prior art example;

FIG. 13 is a flowchart showing an operation example of an intermediate node in the prior art example; and

FIG. 14 is a flowchart showing an operation example of an end node in the prior art example.

### DESCRIPTION OF THE EMBODIMENTS

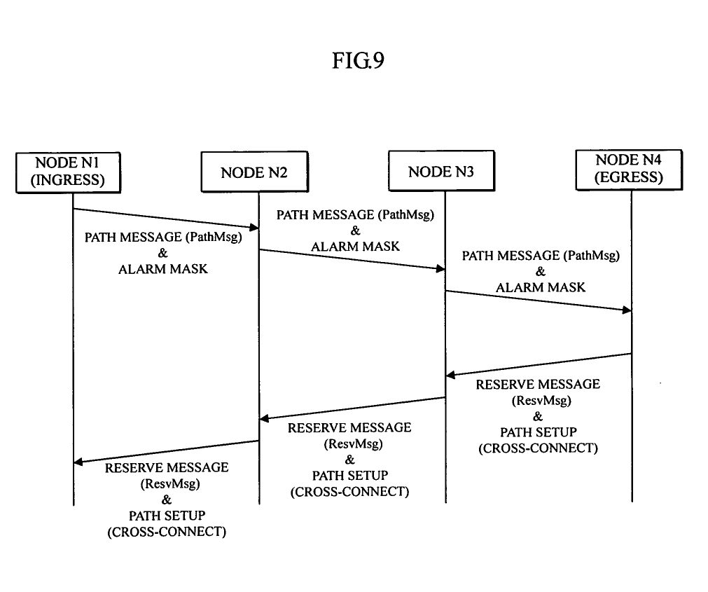

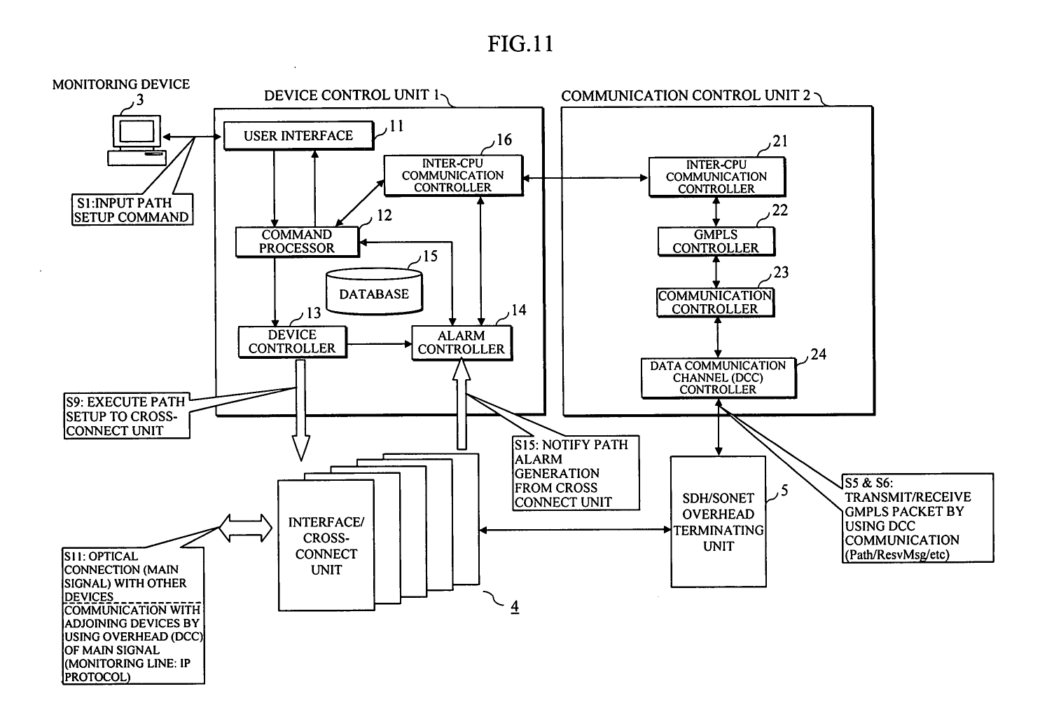

Hereinafter, a node by which the path alarm processing method and device according to the present invention are realized will be described, referring to attached figures, separately for a start node, an intermediate node, and an end node in the same way as the prior art example. It is to be noted that the operation embodiment will be described with a system configuration shown in FIG. 9 as an example. The arrangement of each node is the same as that of the node used in the prior art example shown in FIG. 11.

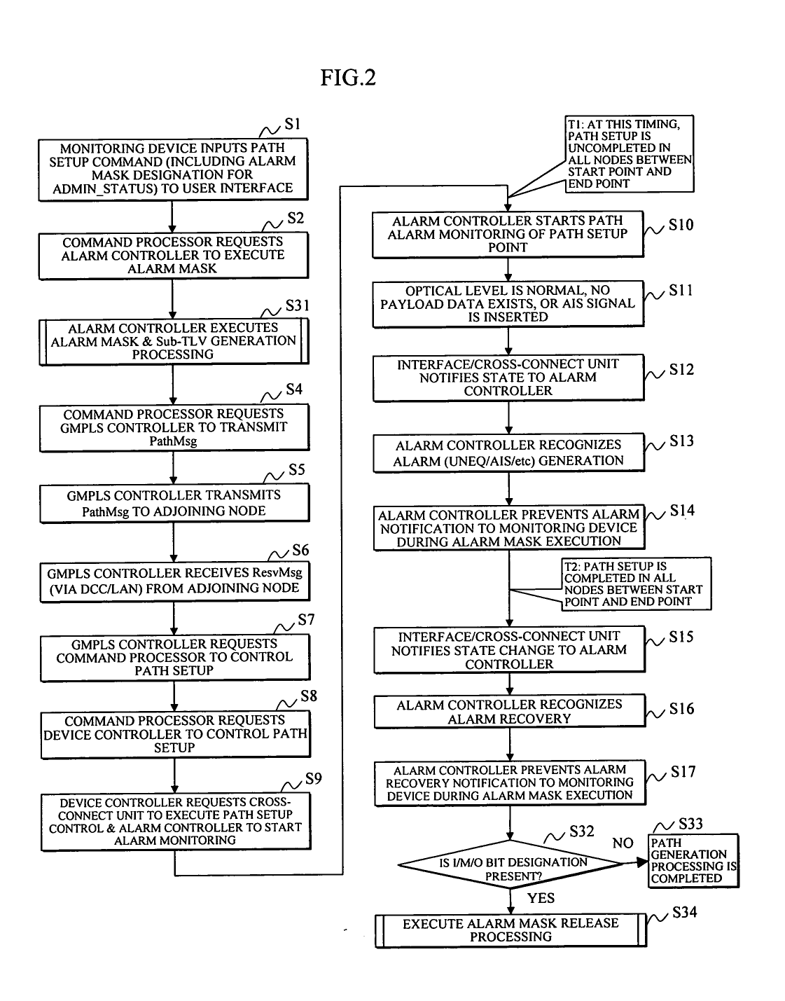

Operation Embodiment of Start Node: FIGS. 2, 3, 4A 4B, 5A-5C, and 6

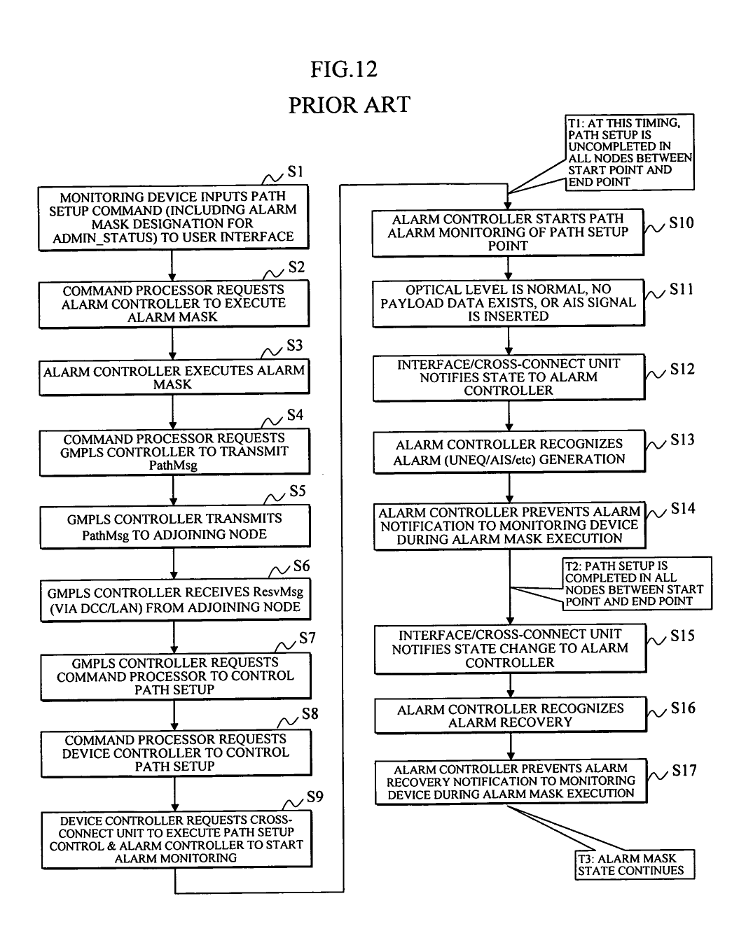

In the operation example of the start node N1 of the present invention, a sub-routine of step S31 is substituted for step S3 for the operation example of the start node in the prior art example shown in FIG. 12. Furthermore, steps S32-S34 are used after step S17, different from the prior art example.

Namely, when executing the alarm mask processing at step S31, the alarm controller 14 also executes Sub-TLV generation processing. Then, the process proceeds to a transmission procedure of the path message PathMsg.

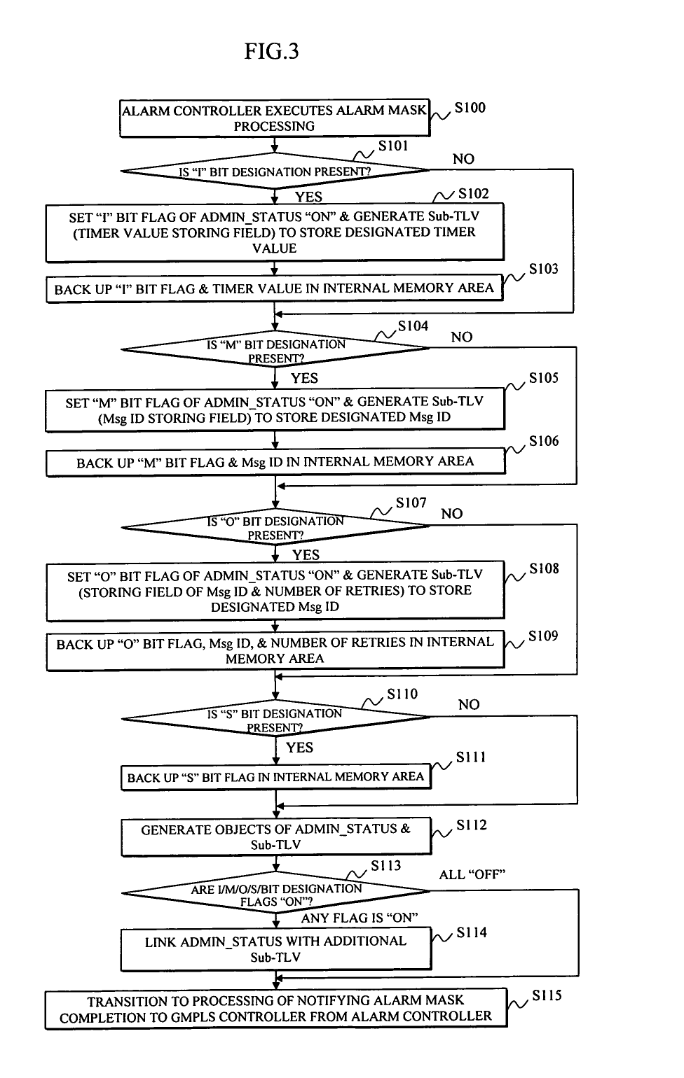

Sub-TLV Generation Processing: FIG. 3

A Sub-TLV generation processing flow will now be described referring to FIG. 3.

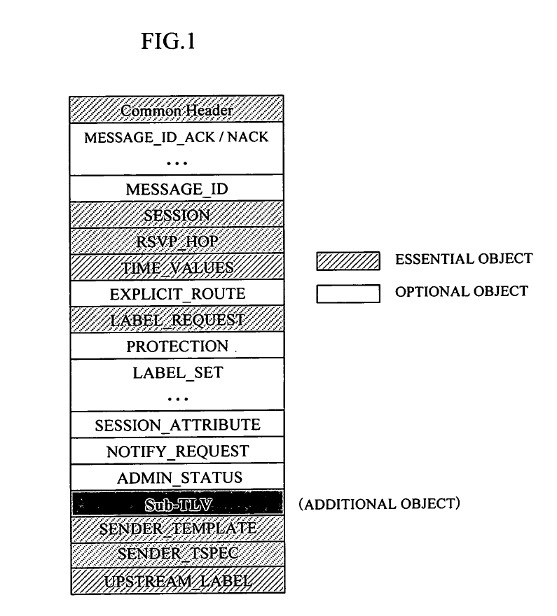

Firstly, when the alarm controller 14 executes the alarm mask processing (at step S100), whether or not “I” bit designation to be set in the Sub-TLV field (object) in the “ADMIN_STATUS” object in the path message PathMsg shown in FIG. 1 has been made is determined (step S10l).

It is to be noted that the “I” bit designation is set by a user from the monitoring device 3 when the alarm mask designation with the “ADMIN_STATUS” object is made at the above-mentioned step S1, and this setting is temporarily stored in e.g. the command processor 12, so that step S101 is executed referring to the command processor 12.

When it is found that the “I” bit designation has been made as a result of the determination at step Sl01, “I” bit flag of the “ADMIN_STATUS” is set “ON”, and a timer value storing field of a Sub-TLV is set, so that a designated timer value is stored (at step S102).

The “ADMIN_STATUS” object in the path message PathMsg and the Sub-TLV (object) added thereto will now be described.

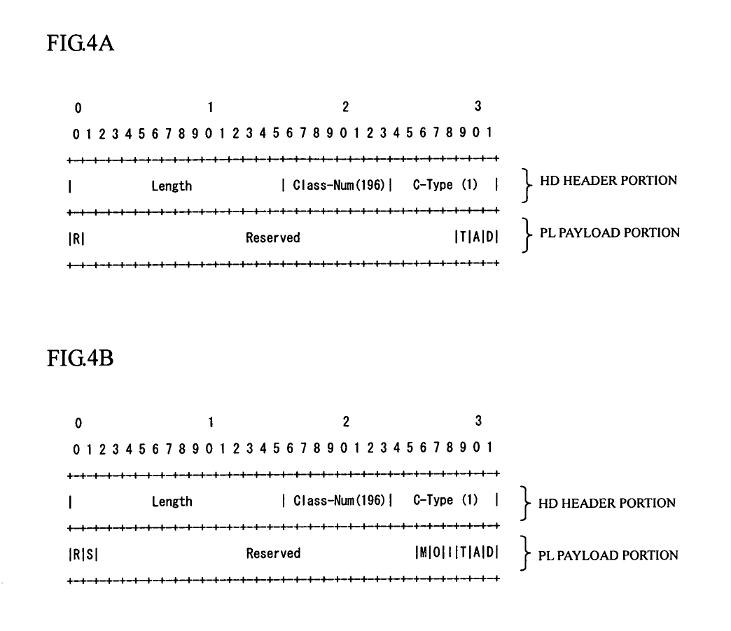

Firstly, FIG. 4A shows a format of the “ADMIN_STATUS” object shown in FIG. 1 which has been used in the prior art example, and is ruled by the RFC 3471 (RFC 3473). A header portion HD within the format is similarly used in the present invention. A payload portion PL includes “Reflect” bit R (1 bit), “Reserved” bits (28 bits), “Testing” bit T (1 bit), “Administratively down” bit A (1 bit), and “Deletion in progress” bit D (1 bit). Among these, “Reserved” bits are in a user option field, undefined in the above-mentioned RFC 3471 (RFC 3473) as unused bits.

In the present invention, as shown in FIG. 4B, a part within the “Reserved” bits is used as follows: It is to be noted that “R”, “T”, “A”, and “D” bits are used in the same way as the prior art example.
(1) “Inhibit Alarm” bit I (1 bit): When this bit is designated or set, the alarm mask is released on condition that a time designated by the Sub-TLV, which will be described later, has lapsed after the reception of the reserve message ResvMsg;
(2) “Message” bit M (1 bit): When this bit is designated, the alarm mask is released on condition that a predetermined message designated by the Sub-TLV has been received;
(3) “Over retry time” bit O (1 bit): When this bit is designated, the alarm mask is released on condition that a predetermined message designated by the Sub-TLV has been received the number of times (or frequency) designated also by the Sub-TLV; and
(4) “Select” bit S (1 bit): When this bit is designated, the alarm mask is released on condition that at least any one of the above-mentioned “I”, “M”, and “O” bits has been set.

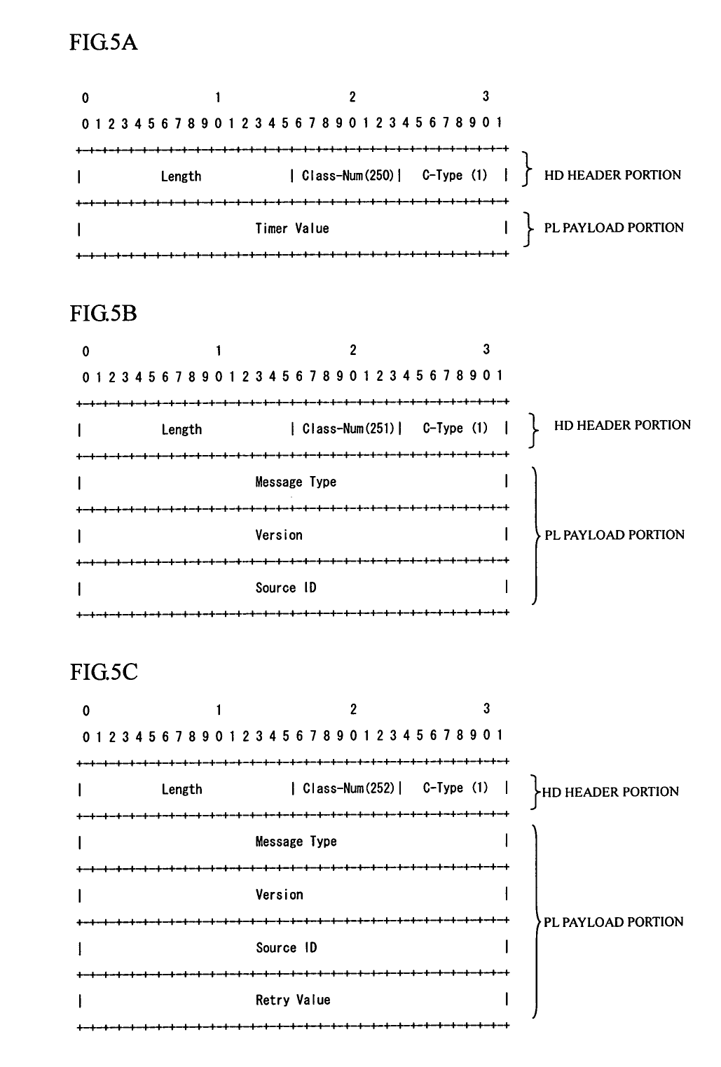

A Sub-TLV structure corresponding to the above-mentioned additional bits (1)-(4) will now be described referring to FIGS. 5A-5C.
(1) Automatic Release by Timer: I Bit

When the “I” bit is designated at the new “ADMIN_STATUS” object shown in FIG. 4B, the Sub-TLV (object) defining a time designated by a timer is added after the “ADMIN_STATUS” object. Based on this, the alarm mask release operation is performed after the time designated by the timer has lapsed after the reception of the reserve message ResvMsg or after a path setup.

The Sub-TLV structure to be added in this case has a format shown in FIG. 5A. In the header portion HD, “250” is newly defined as Class-num. Also, in the payload portion PL, a release time by the timer is designated at “Timer Value” field whose specified range is “0-0x FFFFFFFF (msec)”, and in which 0 indicates an infinite value (no release).
(2) Release by Designation Message: M Bit

When “M” bit flag is set in the “ADMIN_STATUS” object, the Sub-TLV defining a message type is generated, and the alarm mask release is made on condition that the designation message has been received after the reception of the reserve message ResvMsg or after a path setup.

The structure of lang=EN-US>Sub-TLV to be added in this case has a format shown in FIG. 5B. In the header portion HD, “251” is defined as a new Class-num. Also, in the payload portion PL, the message type (ResvConf/Path Msg/RSVP Hello/etc: defined by RFC 3471) is designated by the “Message Type”, and identifying information of a type (IPv4 or IPv6) of “Source ID” is designated for “Version”, and a source IP Address is designated for the “Source ID”.
(3) Release by Receiving Designated Messages Designated Number of Times: O Bit

When “O” bit flag is set in the “ADMIN_STATUS” object, the Sub-TLV defining the message type and the number of times is generated. The alarm mask release is performed on condition that the designation messages have been received the designated number of times after the reception of the reserve message ResvMsg or after a path setup.

The structure of the Sub-TLV to be added in this case has a format shown in FIG. 5C. In the header portion HD, “251” is defined as a new Class-num. Also, in the payload portion PL, “Retry Value” field is provided in addition to the “Message Type”, the “Version”, and the “Source ID” used for the release by the designation message of the above-mentioned (2). In the “Retry Value” field, the number of receptions is designated.
(4) Release on a Plurality of Conditions: “S” Bit

When an “S” bit flag is set in the “ADMIN_STATUS” object, the alarm mask is released when at least any one of the above-mentioned release conditions (1)-(3) is met.

In FIG. 3, when the “I” bit designation is present, the timer value storing field “Timer Value” shown in FIG. 5A is generated, so that the timer value is stored therein (at step S102). The “I” bit flag is set “ON” in an internal memory area of the command processor 12 or the like within the node N1, so that the timer value is stored to be backed up (at step S103).

Then, whether or not “M” bit designation is present is determined (at step S104). As a result, when the “M” bit designation is present, the “M” bit flag of the “ADMIN_STATUS” is set “ON”, and message ID storing fields “Message Type”, “Version”, and “Source ID” are generated as the Sub-TLV as shown in FIG. 5B, where the message ID (Msg ID) is stored (at step S105). The “M” bit flag and the message ID are backed up in the memory area within the node (at step S106).

Then, whether or not “O” bit designation is present is determined (at step S107). As a result, in the presence of the “O” bit designation, the “O” bit flag of “ADMIN_STATUS” is set “ON”, fields “Message Type”, “Version”, “Source ID”, and “Retry Value” storing a message ID and the number of retries are generated for the Sub-TLV as shown in FIG. 5C, so that the message ID and the number of retries are stored (at step S108). The “O” bit flag, the message ID, and the number of retries are backed up in the internal memory area (at step S109).

Furthermore, whether or not an “S” bit designation is present is determined (at step S110). In the presence of the “S” bit designation, the alarm mask is released when any one of the alarm mask release conditions of the above-mentioned I/M/O bits is met. Therefore, the “S” bit flag is backed up in the internal memory area (at step S111).

Thus, the “ADMIN_STATUS” object and the additional Sub-TLV object are generated (at step S112). Whether or not the flags of I/M/O/S bits set as mentioned above are “ON” is determined (at step S113). If any one of the flags is set “ON”, the Sub-TLV object is added after the “ADMIN_STATUS” object (at step S114). The alarm mask completion is notified from the alarm controller 14 to the GMPLS controller 22 (at step S115).

Thus, the Sub-TLV generation processing is executed at step S31 of FIG. 2, so that steps S4-S17 are executed in the same way as the start node in the prior art example.

As a result, the alarm recovery notification to the monitoring device 3 is prevented at step S17, since the alarm mask is being executed. Then the process proceeds to step S32, so that whether or not the designations of I/M/O bits are present is determined. As a result, in the absence of a bit designation, the path setup processing is completed (at step S33). However, in the presence of any bit designation, the alarm mask release processing is executed (at step S34).

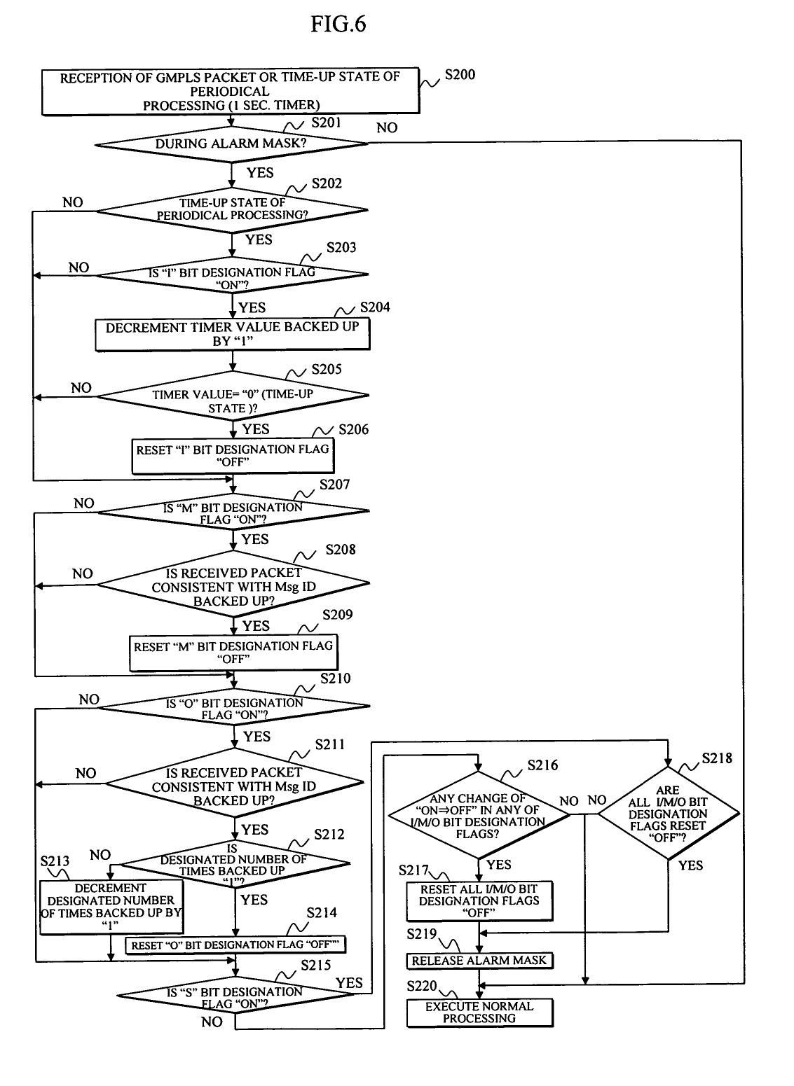

Alarm Mask Release Processing: FIG. 6

FIG. 6 shows an alarm mask release flow.

Firstly, the alarm mask release flow is executed either by the reception of the GMPLS packet or a time-up state per fixed cycle (one second timer) (at step S200).

Firstly, whether or not the alarm mask is being executed is checked (at step S201). As a result, since the alarm mask has been already executed at step S17, whether or not the process should shift to periodical time-up processing is determined (at step S202). This is because the periodical processing per e.g. one second timer is performed in the alarm mask release flow.

Hereafter, whether or not the “I” bit designation flag is “ON” is determined by referring to a backup internal memory area at step S101 of FIG. 3 (at step S203). As a result, when the “I” bit designation flag is “OFF”, the process proceeds to step S207. When the “I” bit designation flag is set “ON”, the timer value backed up in the internal memory area at step S103 of FIG. 3 is decremented by “1” (at step S204). As a result, whether or not the time value is “0”, namely whether or not time is up is determined (at step S205). Only when the time value is “0”, the “I” bit designation flag is reset “OFF” (at step S206).

Then, whether or not the “M” bit designation flag is “ON” is determined from the backup memory (at step S207). As a result, when the “M” bit designation flag is set “ON”, whether or not the message ID set in the reception packet is consistent with the message ID backed up at step S106 is determined (at step S208). As a result, when both are consistent with each other, the “M” bit designation flag is reset “OFF” (at step S209).

Furthermore, whether or not the “O” bit designation flag is “ON” is determined from the backup memory (at step S210). When the “O” bit flag designation flag is “ON”, whether or not the message set in the received packet is consistent with the message ID backed up at step S109 is determined (at step S211). When both message IDs are consistent with each other, whether or not the designated number of times backed up is “1” is determined (at step S212).

As a result, when the designated number of times backed up is not “1”, the designated number of times having been backed up at step S111 is decremented by “1” (at step S213), so that the process proceeds to step S215. If not the case, the “O” bit designation flag is reset “OFF” (at step S214).

Finally, whether or not the “S” bit designation flag is set “ON” is determined (at step S215).

As a result, when the “S” bit designation flag is not set “ON”, whether or not there is a trace of a change from “ON” to “OFF” in any of the I/M/O bit designation flags is determined (at step S216). As a result, when it is found that there is a change from “ON” to “OFF”, all of the I/M/O bit designation flags are reset “OFF” (at step S217).

On the other hand, when the “S” bit designation flag is “ON”, it is determined (at step S218) whether or not all of the I/M/O bit designation flags are “OFF”. When all of the flags are “OFF”, the alarm mask is released in the same way as step S217 (at step S219). Namely, when the “S” bit designation flag is “ON”, and when any one of the I/M/O bit designation flags is “ON”, the alarm mask release is performed.

Hereafter, the process shifts to normal processing (at step S220). In case of “NO” at steps S216 and S218, the process likewise proceeds to step S220 and shifts to the normal processing.

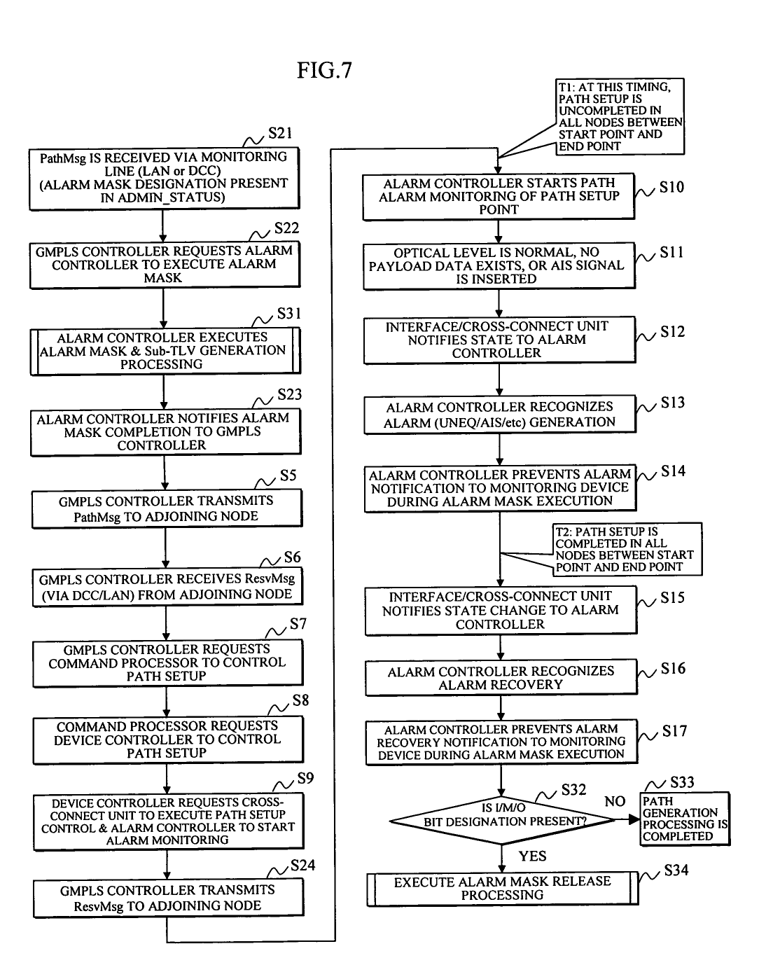

Operation Embodiment of Intermediate Node: FIGS. 7, 3, 4A, 4B 5A-5C, and 6

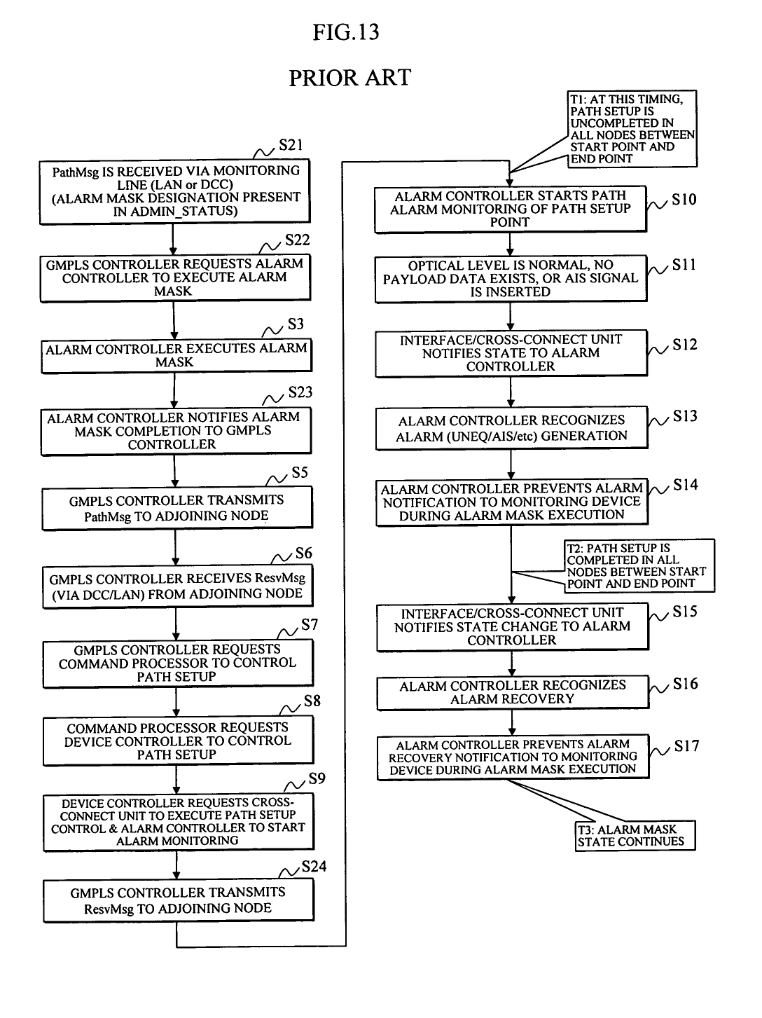

This operation embodiment is different from the prior art example in that step S31 is substituted for step S3 in the prior art operation example shown in FIG. 13, and steps S32-S34 are provided after step S17.

Namely, also in the intermediate node of the present invention, the alarm mask processing and the Sub-TLV generation processing are executed at step S31 in the same way as the operation example of the start node shown in FIG. 2, the alarm recovery notification is prevented at step S17, and then the alarm mask release processing shown in FIG. 6 is executed according to whether or not the I/M/O bit designation is present.

It is to be noted that the embodiments of FIGS. 3, 4A, 4B, 5A-5C, and 6 mentioned above may be also applied to this intermediate node.

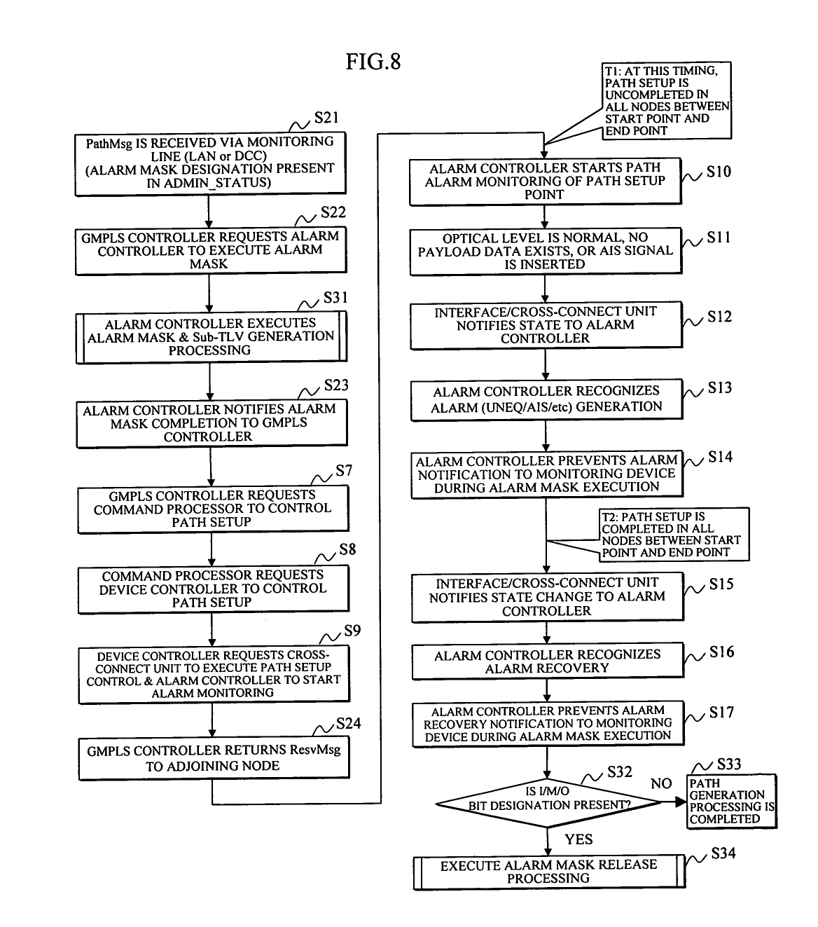

Operation Embodiment of End Node: FIGS. 8, 3, 4A, 4B, 5A-5C, and 6

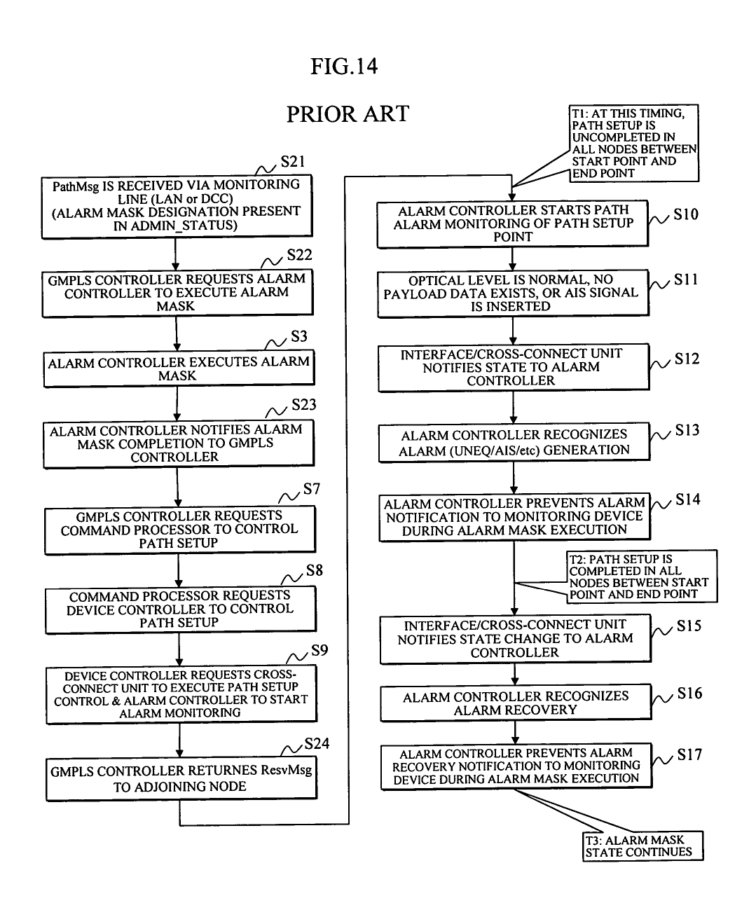

The operation embodiment of the end node is different, compared with the prior art example shown in FIG. 14, in that step S31 is substituted for step S3, and steps S32-S34 are added after step S17.

Namely, also in the case of the end node, in the same way as the above-mentioned intermediate node, the Sub-TLV generation processing is performed together with the alarm mask processing. Even after the alarm recovery notification is prevented, the alarm mask release processing based on FIG. 6 is executed in the presence of the I/M/O bit designations.

It is to be noted that the above-mentioned embodiments of FIGS. 3, 4A, 4B, 5A-5C, and 6 may be applied to this end node.

It is to be noted that the present invention is not limited by the above-mentioned embodiments, and it is obvious that various modifications may be made by one skilled in the art based on the recitation of the claims.

What is claimed is:

1. A path alarm processing method comprising:
a first step of performing an alarm mask release designation together with an alarm mask designation upon path setup; and
a second step of releasing an alarm mask based on the alarm mask release designation when a recovery of a generated alarm is recognized during alarm monitoring.

2. The path alarm processing method as claimed in claim 1, wherein the path setup comprises a path setup by GMPLS.

3. The path alarm processing method as claimed in claim 1, wherein the alarm mask designation and the alarm mask release designation are performed upon path setup command input.

4. The path alarm processing method as claimed in claim 1, wherein the alarm mask designation and the alarm mask release designation are stored in a predetermined field of a path message received upon path setup.

5. The path alarm processing method as claimed in claim 4, wherein the predetermined field comprises an ADMIN_STATUS field in the path message, and unused bits of a Sub-TLV field in the ADMIN_STATUS field are assigned to the alarm mask release designation.

6. The path alarm processing method as claimed in claim 5, wherein the alarm mask release designation is conditional on, by using the unused bits, at least any one of a fixed time having passed after the path setup, a predetermined message indicating the alarm mask release, and a predetermined number of repetitions of the predetermined message.

7. A path alarm processing device comprising:
a first means performing an alarm mask release designation together with an alarm mask designation upon path setup; and
a second means releasing an alarm mask based on the alarm mask release designation when a recovery of a generated alarm is recognized during alarm monitoring.

8. The path alarm processing device as claimed in claim 7, wherein the path setup comprises a path setup by GMPLS.

9. The path alarm processing device as claimed in claim 7, wherein the alarm mask designation and the alarm mask release designation are performed upon path setup command input.

10. The path alarm processing device as claimed in claim 7, wherein the alarm mask designation and the alarm mask release designation are stored in a predetermined field of a path message received upon path setup.

11. The path alarm processing device as claimed in claim 10, wherein the predetermined field comprises an ADMIN_STATUS field in the path message, and unused bits of a Sub-TLV field in the ADMIN_STATUS field are assigned to the alarm mask release designation.

12. The path alarm processing device as claimed in claim 11, wherein the alarm mask release designation is conditional on, by using the unused bits, at least any one of a fixed time having passed after the path setup, a predetermined message indicating the alarm mask release, and a predetermined number of repetitions of the predetermined message.
